(19) United States
(12) Patent Application Publication
(10) Pub. No.: US 2005/0086164 A1
(43) Pub. Date: Apr. 21, 2005

(54) Method for paying a charge using a mobile phone

(75) Inventors: Yong-Hun Kim, Kyunggi-do (KR); Kyu-Seung Lee, Seoul (KR)

Correspondence Address: ROTHWELL, FIGG, ERNST & MANBECK, P.C., 1425 K STREET, N.W., SUITE 800, WASHINGTON, DC, 20005, US

(73) Assignee: GRIM Electronics Company, Ltd., Seoul (KR)

(21) Appl. No.: 10/934,740

(22) Filed: Sep. 7, 2004

Related U.S. Application Data
(63) Continuation of application No. 09/411,324, filed on Oct. 4, 1999, now abandoned.

(30) Foreign Application Priority Data
Feb. 23, 1999 (KR) 99-5946

(51) Int. Cl. G06F 17/60; H04K 1/00

(52) U.S. Cl. 705/40; 455/406

(57) ABSTRACT

The present invention relates to method utilizing a mobile phone as a tool to pay a charge of goods or service rendered through approval of a mobile phone network. According to the method of using the mobile phone to pay a charge on purchasing goods or service, first a buyer uses his or her mobile phone to connect to a payment transaction server, the buyer and merchant store identification code and the bill for the goods is transmitted to the payment transaction server. At this point, the payment transaction server examines the information data received from the mobile phone and determines the approval of the transaction based on the balance corresponding to the buyer identification code, if it is approved the payment transaction server sends the approval notification to a terminal at the merchant store. The information for accessing the terminal is determined depending upon the merchant store identification code. After the confirmation from the approval notification at the merchant store, a seller transfers a goods to a buyer or provides a buyer with a necessary service.

### BACKGROUND OF THE INVENTION

1. Field of the Invention

The present invention relates to method utilizing a mobile phone as a tool to pay a charge of goods or service rendered through approval of a mobile phone network.

2. Description of the Related Art

A conventional method of purchasing and selling is mostly done by cash, or by a credit card. When paying a charge by credit card, a buyer presents a credit card at a merchant store equipped with a credit card reader after purchasing a goods. The credit card reader is connected to the credit card transaction server to request transaction and to receive the payment approval.

A buyer must always carry a credit card to use this kind of payment method. However, the loss of the credit card is common. Moreover credit card is mostly used for paying not a small charge, which causes a credit card to be rarely used. Therefore, it is difficult to notice the loss of the credit card in the event of loss although the lost credit card is being used in fraud.

In the credit card paying method, the authenticity of a buyer is confirmed by the data recorded on the magnetic strip of a credit card, therefore it is vulnerable to forgery and because of this, thousands of dollars are lost due to forgery of credit cards.

Also, purchasing a goods with the credit card needs a multi-step process, where small charge transactions by a credit card are restricted, therefore even with the possession of credit cards, the inconvenience follows because a buyer has to carry some amount of cash for goods or service that costs low expense. The merchant store to subscribe to credit card service requires a device such as a credit card reader unit and necessary accessories and it is true that this investment has made it difficult for merchant stores with goods which are low cost to subscribe to credit card service.

Unlike the above-mentioned method that a buyer purchases from the merchant store, catalog-order purchases are done by telephone calls, through the telephone calls you have to select a product you want to purchase, and providing mailing address and the credit card information for billing purpose. The catalog-order company with the buyer's information requests payment to the credit card payment server.

However, with this method, each time a buyer wishes to purchase goods from catalog-order companies he or she undergoes the inconvenience to provide the personal information through the telephone to the catalog-order company.

### SUMMARY OF THE INVENTION

It is an object of the present invention to provide method and apparatus enabling a buyer to purchase small-charge goods or service with the mobile phone with ample amount of convenience and security.

The method paying a charge using a mobile phone according to the present invention comprises the steps of: (a) connecting to a payment transaction server through the mobile phone; (b) transmitting a payment request data containing information identifying a store and a buyer and an amount of money to be paid through a mobile phone network; (c) checking the payment request data received and a balance associated with the identified buyer for approval of the payment; and (d) transmitting a payment approval data containing information on the amount of money approved to a terminal other than the mobile phone based on the checked result, the terminal being designated from pre-registered information on the identified store.

According to the method of using the mobile phone to pay a charge on purchasing goods or service, first a buyer uses his mobile phone to connect to a payment transaction server, the buyer and merchant store identification code and the bill for the goods is transmitted to the payment transaction server.

At this point, the payment transaction server examines the information data received from the mobile phone and determines the approval of the transaction based on the balance corresponding to the buyer identification code, if it is approved the payment transaction server sends the approval notification to a terminal at the merchant store. The information for accessing the terminal is determined depending upon the merchant store identification code. After the confirmation from the approval notification at the merchant store, a seller transfers a goods to a buyer or provides a buyer with a necessary service.

### BRIEF DESCRIPTION OF THE DRAWINGS

The accompanying drawings, which are included to provide a further understanding of the invention, illustrate the preferred embodiment of this invention, and together with the description, serve to explain the principles of the present invention.

In the drawings:

FIG. 1 is the illustration of the network of the system for payment using the mobile phone according to the present invention;

FIG. 2 is a block diagram of a payment transaction server according to the present invention;

FIG. 3 is a flowchart depicting the sequence of charge paying method using the mobile phone according to the present invention; and

FIGS. 4A and 4B are the example of the information stored on the hard disk device in FIG. 2.

### DETAILED DESCRIPTION OF THE PREFFERRED EMBODIMENTS

In order that the invention may be fully understood, preferred embodiments thereof will now be described with reference to the accompanying drawings.

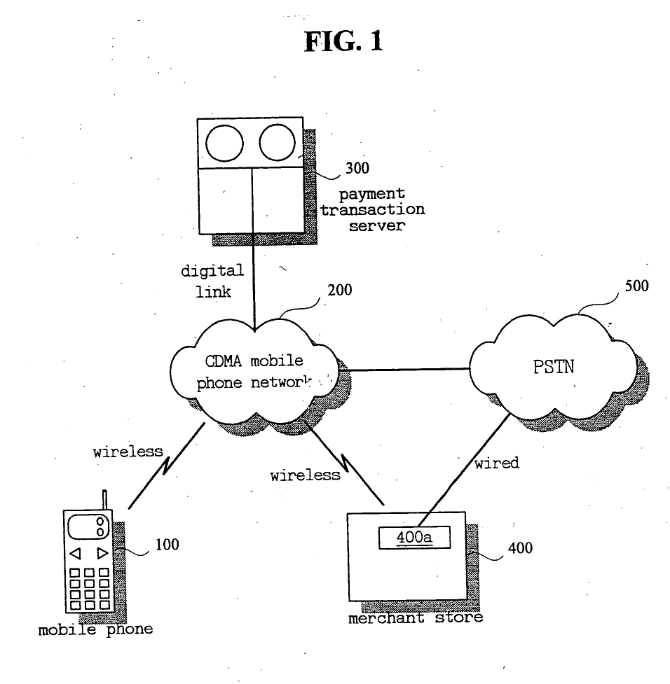

FIG. 1 is the illustration of the network of the system embodying the present invention for paying a charge using the mobile phone. FIG. 1 shows the mobile phone 100, Code Division Multiple Access (CDMA) mobile network 200, a payment transaction server 300, and a merchant store 400 with a communication terminal 400a to be connected by wireless to the CDMA mobile network 200 or to be connected in wire to a Public Switched Telephone Network (PSTN) 500.

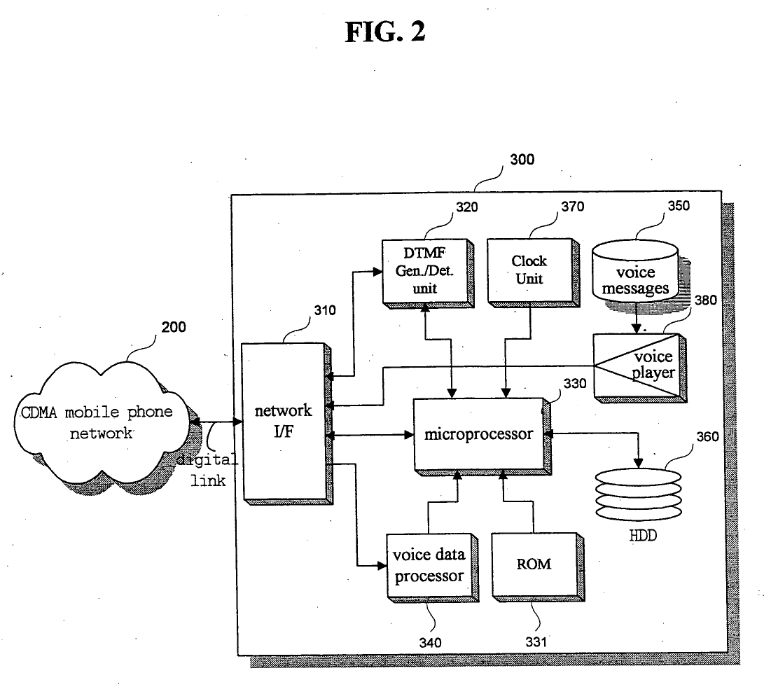

FIG. 2 is a block diagram of the payment transaction server 300 of FIG. 1 embodying the present invention. The payment transaction server 300 consists of a network interface 310 connected to the CDMA mobile network 200 to process call signaling and transmit/receive data signals; a DTMF generating/detecting unit 320 converting telephone numbers into DTMF tone signals and detecting DTMF tone from the received signal; a voice data processor 340 digitizing the voice signal received through the network interface 310 and extracting voice characteristics such as voice patterns from the digitized voice data; a voice message storage disk 350 containing voice guidance message as digital data; a hard disk device 360 storing programs, all subscribers' (buyers') addresses, telephone numbers, remaining balances, and security codes etc. and information on all registered merchant stores; a clock unit 370 providing the current date and time; a voice player 380 restoring the compressed voice data recorded in the voice message storage disk 350 into real voice; and a microprocessor 330 executing programs in a ROM 331 and the hard disk device 360, searching the hard disk device 360, and updating the data written in the hard disk device 360 if necessary.

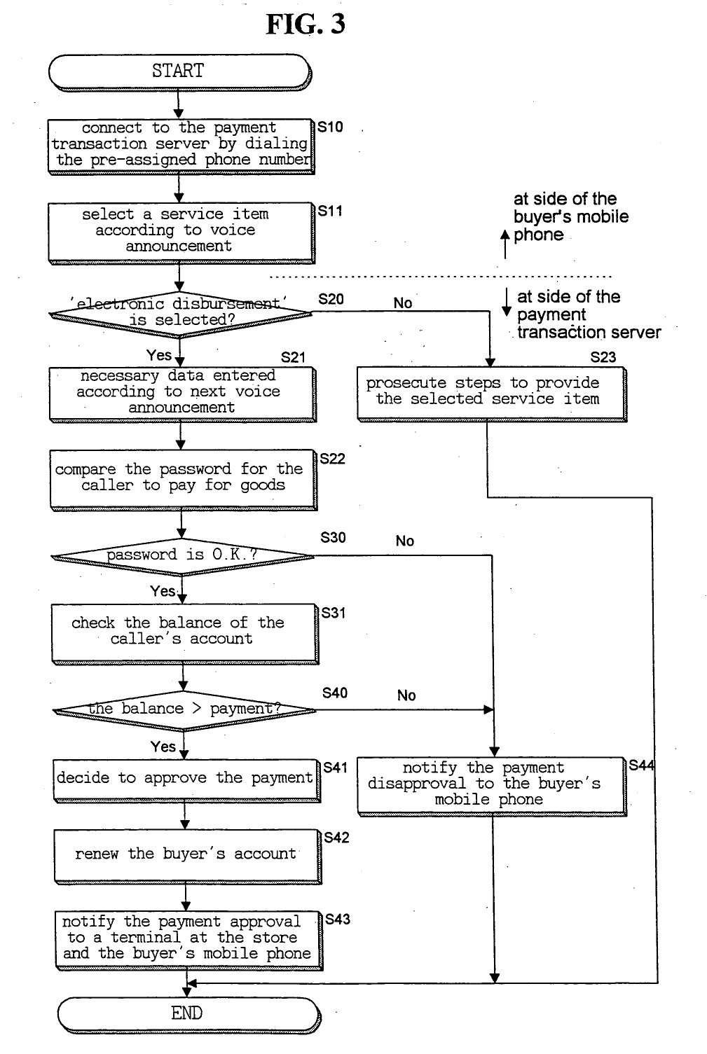

FIG. 3 shows the flowchart of charge paying method using the mobile phone according to a preferred embodiment of the present invention. Referring to the network configuration of FIG. 1 and the block diagram of FIG. 2, the example sequences of charge paying method in shown FIG. 3 will be explained in detail.

First, a person with a mobile phone subscribes to the mobile phone payment service provider in order to use the mobile phone as a payment tool. On a time period basis (e.g. each month), the subscriber is assigned a certain amount of money in connection with the person's pre-registered information in the payment transaction server 300. If the person uses the mobile phone to pay a charge, the assigned money is decreased by the amount paid.

In the mobile phone (100) a mobile phone number and a mobile phone identification code are stored. Therefore, if a user dials a prescribed phone number, for example “*89” with the mobile phone 100 to request the payment to the payment transaction server 300, the dialed telephone number will be transmitted to a proximate base station (BTS) of the CDMA mobile network 200 together with the stored data of the mobile phone number and the identification code to setup a call connection.

The BTS received the call request data from the mobile phone 100 transmits it to a base station controller (not figured) where the mobile phone number and the mobile phone identification code are checked for legitimacy, if the caller is legitimate, the call is switched to the payment transaction server 300 through the mobile CDMA network 200, and a virtual circuit connection between the calling mobile phone 100 and the called payment transaction server 300 is then established (S10).

While the call connecting procedure, the microprocessor 330 of the payment transaction server 300 recognizes the call request arrived through the network interface 310, detects the telephone number of the calling mobile phone 100 from the call request signal.

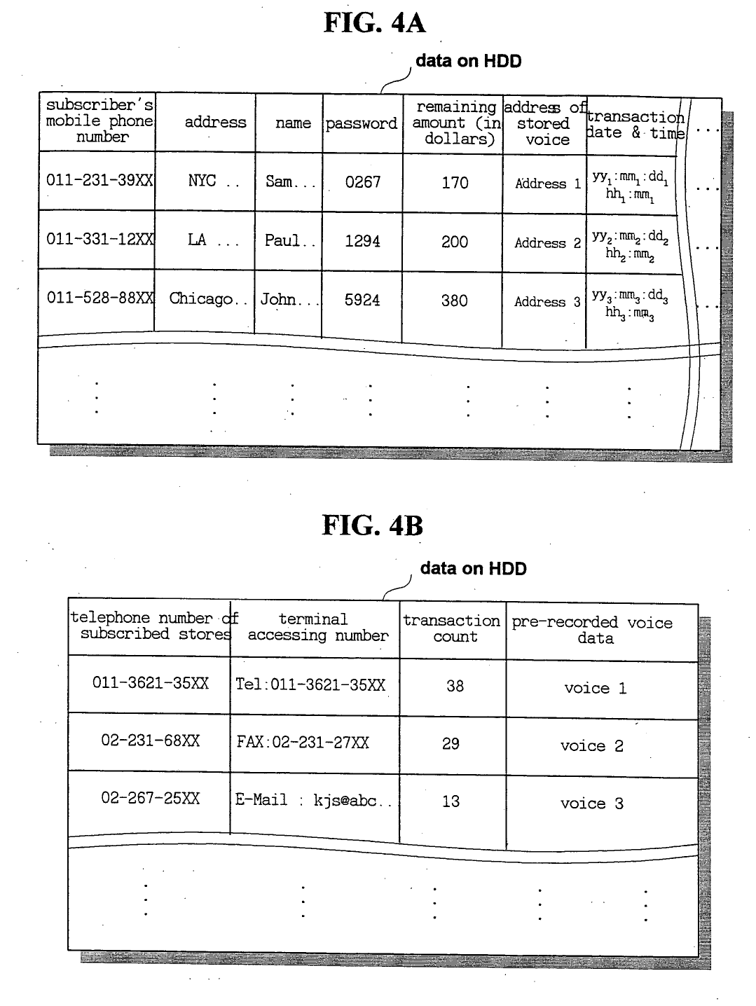

From this, the microprocessor 330 searches the hard disk device 360 where information on merchant stores and subscribers (buyers) is stored like as shown FIGS. 4A and 4B for the detected mobile phone number. If the mobile phone number is discovered, the microprocessor 330 verifies that the person who generates this call is a subscriber to pay a charge using a mobile phone and identifies the buyer to pay a charge in electronic.

If the caller is a person registered in the mobile phone payment service, the microprocessor 330 retrieves the appropriate voice message to guide service menu selection from the voice guidance messages stored in the voice message storage disk 350. The retrieved voice message, which is compressed, is decompressed into real voice data by the voice player 380 and is then transmitted through the network interface 310 to the mobile phone 100 where the voice sounds are generated so that the caller knows how to enter next step while the payment transaction server 300 goes into standby mode for further user instruction.

The voice message for service menu selection may be sounds as follows.

“Please enter the number for the service you wish to use,
1: check balance
2: mobile phone loss report
3: electronic disbursement transaction
4: paid contents
. . . .”

The caller selects one from the above service menu (S11). The selection is made by the dial button pressed on the mobile phone 100 or natural voice of the caller.

If the caller selects #3 service of ‘Electronic disbursement transaction’ by sending natural voice through the mobile phone 100 (S20), the microprocessor 330 controls the voice data processor 340 to convert the voice received through the network interface 310 into digital compressed data and stores the converted compressed data. Also the microprocessor 330 read the current date and time of the clock unit 370 and then, as shown FIG. 4A, stores them together with the address of the stored compressed data in connection with the registered telephone number detected in the previous call setup procedure. The voice data processor 340 also extracts the voice pattern from the received voice data, and the microprocessor 330 compares the extracted voice pattern with pre-stored voice pattern of the pronunciation of “Electronic Disbursement Transaction” and then recognizes the caller has selected ‘electronic disbursement transaction’ when two compared patterns are similar within the allowable deviation.

The reason why the natural voice pronounced by the caller is stored together with the current date and time data in the hard disk device 360 of the payment transaction server 300 is to provide a proof of the caller's paying request when the caller makes a denial of having requested payment or problems occur later on.

Subsequently, the microprocessor 330 reads out announcement messages to guide to enter necessary data sequentially for the selected ‘electronic disbursement transaction’ service from the voice message storage disk 350 and transmits them to the connected mobile phone 100 through the network interface 310. After this, the payment transaction server 300 returns the standby mode again until the user reacts.

As listening to the voice announcement messages through the mobile phone 100, according to the announcement message the caller sends the necessary data for the ‘electronic disbursement transaction’ sequentially by pressing the dial buttons on the mobile phone 100 (S21). The necessary data consists of the phone number of the terminal 400a in the merchant store 400, money to be paid for goods or service, and password. The DTMF generating/detecting unit 320 detects the DTMF tone signal from the received signal through the network interface 310, and the microprocessor 330 checks the entered data by the caller based on the detected DTMF tone signals.

To check the correctness of the entered data, the microprocessor 330 retrieves and sends the pre-stored voice data corresponding to the detected DTMF signal to the connected mobile phone 100 through the network interface 310. Therefore, the caller confirms the entered data by listening to the voice message.

Through the voice message echoed back, the caller confirms the correctness of the entered data. In this confirmation step, when error in the entered data is perceived the caller returns to the appropriate entering step of the payment transaction server 300 to re-enter necessary data.

Instead of entering the necessary data for paying a charge for a goods or a service as explained above, natural voice can be used to enter the necessary data if extracting voice pattern and comparing it with pre-stored patterns are applied as in detection method of the service menu selection mode explained above to this entering step.

The microprocessor 330 reads out the registered password pre-stored in connection with the discovered mobile phone number as shown FIG. 4A from the hard disk device 360 and compares it with the received password among the entered data (S22). IF the two passwords are identical (S30), the microprocessor 330 verifies the identity of the buyer, and determines whether to carry out the approval step to complete the payment transaction.

For this determination, the microprocessor 330 compares the money to be paid with the remaining balance of the identified buyer in the hard disk device 360 (S31). If the requested amount to pay does not go over the available account balance (S40), the microprocessor 330 decides to approve the payment transaction (S41).

After the decision to approve, the microprocessor 330 reduces the remaining balance by the amount approved to be paid (S42).

The microprocessor 330 takes step to notify the terminal 400a at the merchant store 400 and the mobile phone 100 of the payment approval (S43), for notifying the terminal 400a the microprocessor 330, first searches for the received phone number of the terminal 400a in the hard disk device 360, increases the transaction count stored in connection with the phone number of the terminal 400a as shown FIG. 4B if it discovered, and constructs a approval message containing the increased transaction count, the amount paid for a goods or a service, the received buyer's mobile phone number and security information such as a caller (the payment transaction server 300) telephone number to make a seller at the merchant store 400 believe that the approval message is originated and the sale is guaranteed from the payment transaction server 300.

The received phone number of the merchant store 400 is transmitted to the DTMF generate/detect 320 where the phone number data is converted into DTMF tone signal, and the converted DTMF tone signal is transmitted to the CDMA mobile network 200 through the network interface 310. A data path between the payment transaction server 300 and the communication terminal 400a, which may be a mobile phone of the seller, is to be setup by the transmission of the DTMF tone signal. The communication terminal 400a of the merchant store 400 could be a CDMA mobile phone, a wire-line telephone, or a wire-line exclusive payment terminal. If it is a wire-connected terminal the data path would be established through the public switched telephone network (PSTN) 500.

When the communication terminal 400a of the merchant store 400 is connected to the payment transaction server 300 through the network, the microprocessor 330 transmits the constructed approval message to the terminal 400a.

At the time of transmitting the approval message, the microprocessor 330 also reads out and transmits the caller information such as the post address, name, house phone number stored in the hard disk device 360 to the terminal 400a of the merchant store 400 in case that the caller selects the option to provide personal information on the voice menu of the ‘electronic disbursement transaction’ service. The personal information provided from the payment transaction server 300 is referenced when the merchant store 400 uses post or courier service for delivering one or more goods chosen by the buyer.

The reason why the transaction count of the merchant store 400 as well as the phone number of the payment transaction server 300 are transmitted is to prevent a buyer and another third party from conspiring together to transmit a fraud approval message to the terminal 400a of the merchant store 400. The payment transaction server 300 may transmit either the transaction count or the phone number of a caller originating the approval message.

To figure the genuineness of the approval message, the following method different from the mentioned above can be adopted. The specific voice of a representative of the merchant store 400 is recorded in advance on the hard disk device 360 in digital voice data as shown FIG. 4B when subscribing to the mobile phone paying service. The microprocessor 330 transmits the recorded specific voice to the communication terminal 400a before sending the constructed approval message when a call to the terminal 400a is connected. Therefore, a seller of the merchant store 400 can confirm that the approval message following the recorded voice is originated from the genuine payment transaction server 300 after carefully listening the voice sound from the terminal 400a.

Also, In addition to being notified to the merchant store's mobile phone or wire-line telephone as mentioned above, the approval message of the payment transaction server 300 can be notified to a facsimile or as an E-mail.

The microprocessor 330 reports the payment approval to the buyer's mobile phone 100 as well. In the course of reporting, the microprocessor 330 transmits information on whether the requested payment is allowed or not and available balance amount after converting them into corresponding voice through the voice data processor 340. This procedure enables the buyer to check if the purchase is normally completed and confirms the buyer's remaining account balance for future payment.

When notifying of the payment approval, other than using the voice message notification, the microprocessor 330 may uses another mobile communication utility service such as Short Message Service (SMS) for notification. The Short Message Service uses the access/paging channel or the traffic channel to send or receive a short messages to or from other mobile phone without normal call setup. The user data field of current SMS protocol can accommodate maximum 255 characters.

In case that SMS method is adopted for notification of payment approval, the microprocessor 330 forms a short message including the payment transaction information relating an approval and transmits it to the a CDMA base station which is closest to the merchant store 400. the closest CDMA base station transmits the received information to the mobile phones of the buyer and the merchant store through a access/paging channel of CDMA channels.

If the transactions history is requested to the payment transaction server 300 from the merchant store 400, the payment transaction sever 300 searches the hard disk device 360 for the terminal accessing code such as mobile phone or facsimile number, E-mail address, which is inputted from a seller at the requesting time, to identify the merchant store 400 and transmits the transaction history associated with the identified merchant store for the fixed period, for example a month, to the terminal specified by the terminal accessing code.

According to the procedures described until now, each subscriber uses the mobile phone to purchase and pay for goods or service rather than paying with the conventional cash or credit card. The payment transaction server 300 periodically (e.g. Each Month) calculates each subscriber's total used amount (goods payment and telephone fee) and provides the calculated amount in the form of a electronic bill to each user, and then each user settles the bill to a wireless telephone service provider which is operating the payment transaction server 300. The wireless telephone service provider also settles each sale accounts of merchant stores recorded on the hard disk device 360 to correspondent bank accounts.

The payment transaction server 300 resets the account for each subscriber to the maximum limit pre-assigned on the subscription to mobile phone paying service.

The above-explained method according to the present invention enables a buyer not to possess cash and credit cards which are exposed to theft and loss, but to carry only a mobile phone which is secure and protected to fraud, so that mobile phone can be put into place to replace the former payment process by simplicity of use. This mobile phone paying method also eliminate troublesome steps to provide a seller at stores on network with credit card numbers and other personal information. The merchant store could use their own conventional terminal such as mobile phone or telephone to receive transaction approval therefore without any investment costs for an additional exclusive terminal like a credit card reader. These advantages may expand the dealings on credit.

1. A method of paying for a goods or service by using a mobile phone, comprising the steps of:
(a) connecting to a payment transaction server through the mobile phone;
(b) transmitting a payment request data containing information identifying a store and a buyer and an amount of money to be paid through a mobile phone network;
(c) checking the payment request data received and a balance associated with the identified buyer for approval of the payment; and
(d) transmitting a payment approval data containing information on the amount of money approved to a terminal other than the mobile phone based on the checked result, the terminal being designated from pre-registered information on the identified store.

2. A method according to claim 1, wherein the data communication among the mobile phone, the payment transaction server, and the terminal is done through a Code Division Multiple Access (CDMA) mobile phone network.

3. A method according to claim 1, wherein the information identifying a buyer is a mobile phone number which is automatically transmitted from the mobile phone during call setup procedure.

4. A method according to claim 1, wherein said step (c) comprises:
transmitting the information on the amount of money to be approved to the mobile phone through the mobile phone network;
receiving a data indicating whether the amount of money to be approved is correct or not from the mobile phone; and
determining whether to approve the payment depending upon the received data

5. A method of paying for a goods or service by using a mobile phone, comprising the steps of:
(a) receiving a payment request data containing information identifying a store and a buyer and an amount of money to be paid from the mobile phone connected;
(b) identifying a buyer's account depending upon the information identifying a buyer;
(c) determining whether to approve the payment based on the received amount of money to be paid and the balance in the identified buyer's account;
(d) identifying a terminal of the store depending upon the information identifying a store; and
(e) transmitting a payment approval data containing information on the amount of money approved to the identified terminal.

6. A method according to claim 5, wherein said step (c) further comprises the step of decreasing the balance in the buyer's account by the amount of money to be paid when determining to approve the payment.

7. A method according to claim 5, wherein said step (a) comprises the steps of:
transmitting pre-recorded voice selection menu to the mobile phone connected;
confirming that a payment request is selected after analyzing voice data received from the mobile phone; and
receiving the payment request data containing the information identifying a store and a buyer and the amount of money to be paid from the mobile phone through a mobile phone network.

8. A method according to claim 7, wherein the received voice data is stored together with the amount of money to be paid.

9. A method according to claim 5, wherein the information identifying a store and the amount of money to be paid are entered through the dial buttons on the mobile phone.

10. A method according to claim 5, wherein the payment approval data further contains the identified buyer's personal information such as name and postal address.

11. A method according to claim 5, wherein the payment approval data further contains a transaction count associated with the identified store, the transaction count being incremented whenever a payment approval data is transmitted.

12. A method according to claim 5, wherein the payment approval data further contains a data indicating that the payment approval data is originated from a predetermined payment transaction server.

13. A method of paying for a goods or service by using a mobile phone, comprising the steps of:
(a) receiving a payment request data containing information identifying a store and a buyer and an amount of money to be paid from the mobile phone connected;
(b) identifying a buyer's account depending upon the information identifying a buyer;
(c) determining whether to approve the payment based on the received amount of money to be paid and the balance in the identified buyer's account;
(d) identifying a terminal of the store depending upon the information identifying a store;
(e) connecting to the identified terminal;
(f) sending pre-recorded voice associated with the store to the connected terminal; and
(g) transmitting a payment approval data containing information on the amount of money approved to the connected terminal.

14. A method according to claim 13, wherein the pre-recorded voice is natural voice of a representative of the store.

15. A method of paying for a goods or service by using a mobile phone, comprising the steps of:
(a) receiving a payment request data containing information identifying a store and a buyer and an amount of money to be paid from the mobile phone;
(b) determining whether to approve the payment request based on the received amount of money to be paid and the balance in the account identified by the information identifying a buyer; and
(c) transmitting a payment approval data containing the received information identifying a buyer to a terminal determined based on the information identifying a store.

16. A method according to claim 15, wherein the information identifying a buyer is a mobile phone number.

17. A method according to claim 15, wherein the payment approval data further contains information on the amount of money approved.
